(19) United States
(12) Patent Application Publication
(10) Pub. No.: US 2010/0217702 A1
(43) Pub. Date: Aug. 26, 2010

(54) Electronic System for Coordinating Contracts Relating to Property

(76) Inventor: Vinh Tu, Ottawa (CA)

Correspondence Address: ROBERT PLOTKIN, PC, 15 New England Executive Office Park, Burlington, MA, 01803, US

(21) Appl. No.: 12/293,630

(22) PCT Filed: Mar. 21, 2007
(86) PCT No.: PCT/CA07/00442

§ 371 Date: Sep. 19, 2008

Related U.S. Application Data
(60) Provisional application No. 60/743,623, filed on Mar. 21, 2006.

(51) Int. Cl. G06Q 40/00; G06Q 90/00; G06Q 50/00; G06Q 20/00

(52) U.S. Cl. 705/37; 705/500

(57) ABSTRACT

A system, method and apparatus using devices connected to an electronic network to enable users to locate other users for the purpose of entering into option contracts for the purchase and sale of goods and other property, and to coordinate secured lending transactions.

### FIELD OF THE INVENTION

This invention relates in general to a method and electronic system for coordinating contracts for options to buy and sell goods and other property, and for arranging secured lending transactions.

### BACKGROUND

The availability of credit enables consumers to maximize their living standards. By shilling resources from the future to the present or whenever it is most needed, consumers can use those resources more optimally. Liquidity and capital may be required for personal, financial or business reasons. Prior to the introduction of the credit card, credit was often extended by shopkeepers to their customers. More recently, credit cards have become widespread. However, there remain many consumers who do not have access to, or choose not to use, credit cards, bank loans, or other conventional forms of credit.

### Lenders

One of the problems in lending is that the lender faces the risk of the borrower defaulting on the loan. There are people who do not have adequate credit histories and to whom lenders are therefore unwilling to extend credit. To compensate for risk, lenders typically demand high levels of interest. Loan sharking and other abusive practices may occur.

One solution to the problem of credit risk is the use of security or collateral. Lending against security has a very long history. One example is the mortgage, wherein land is pledged against a loan. In other cases, collateral such as tangible personal property has been used to secure loans. Often, the property which the borrower is buying, such as a vehicle or appliance, is used as collateral against the loan.

Pawn shops or pawnbrokers have traditionally allowed people to borrow money by leaving personal possessions in the care of the pawn shop. Even though borrowers leave personal property as guarantees against the loan, pawnbroking businesses typically make large accounting reserves against the possibility of defaulted or bad loans.

In an automobile title loan, title to an automobile is used to secure a loan. If the borrower defaults on the loan, the lender has the contractual right to repossess and sell the automobile.

Mortgage loans are secured by real property. If the borrower defaults on the loan, the lender may foreclose and sell the property to recover the debt.

According to the National Pawnbrokers Association, approximately 80% of loans are repaid. The apparent implication is that possibly 20% of loans result in default. From the perspective of the borrower, since pawn shop loans are “no-recourse” loans, the borrower enjoys the advantage of avoiding the risk of damage to credit and the danger of bankruptcy. From the perspective of the lender, however, there is a risk of being left with unwanted goods that must then be sold to at least recoup the money lent. Because deposited goods may be of a varied and random nature, it may be difficult to sell these goods promptly, in order to recoup costs, recover storage space and maintain cash flow. To increase the chance of resale for forfeited goods, most pawnbrokers restiict the type of accepted goods to higher value items such as jewelry, musical instruments, tools, electronics and, where permitted, firearms.

One difficulty in pawnbroking is that, at the time of the loan transaction, the value of goods must be appraised by the pawnbroker. The appraisal typically is done quickly, and relies on the expertise of the pawnbroker. The appraisal is therefore likely to be conservative, resulting in a smaller amount of credit being extended to the borrower. Furthermore, because the lender typically prefers loan repayment as opposed to the forfeiture of the collateral, higher rates of interest must often be charged to compensate for the risk of being left holding the undesired merchandise that may not be easy to sell. The overhead cost of needing to store and market the goods received from defaulters is significant. Ultimately, this cost is passed onto borrowers in the form of higher interest rates and lower loan amounts relative to the true value of the collateral. Given that pawn shop transactions tend to be short term, the rapid turnover and the high default rate of transactions result in a large cost to doing business. As a result, while unsecured credit card loans can have interest rates ranging as high as 28% per annum, a secured pawn shop loan can have an interest rate as high as 300%. As such, economic inefficiencies exist in the current pawnbroker system which result in less credit being available to individuals with limited access to conventional sources of credit. These economic inefficiencies also result in the necessity to charge higher interest rates.

One means of disposing of property is to sell it with the aid of an online market. Various electronic systems exist for the sale such as auctioning of goods online. eBay™ is one well-known online auction system. Through an online auction, sellers can offer items for sale and tap a large market of potential buyers. The auction mechanism enables the market to determine the ultimate price at which the item is sold. Pawnbrokers currently can use eBay or similarly structured systems to liquidate their inventory of forfeited merchandise.

E-commerce facilitates the trade in goods by leveraging the power of the internet to match buyers and sellers. Often, value is extracted from goods that otherwise lie passive in people's attics and basements. In addition to benefiting collectors and other consumers, online auctioning has also given rise to professional merchants who locate and buy goods at relatively low prices and resell those goods at higher prices. These intermediaries contribute to the market's efficiency. The majority of current sales for online auction sites involve a professional or semi-professional seller, rather than two ordinary consumers. This reflects the fact that, even with the advent of electronic search engines, skilled intermediaries can add value by locating goods and sourcing bargains and then marketing those goods to interested consumers.

Priceline discloses in U.S. Pat. Nos. 5,794,207 and 6,085,169 yet another online system for matching parties in a sale of goods or services.

Other online systems, such as Craigslist, exist to connect parties to a transaction without providing a matching or clearing function.

Other electronic matching systems such as systems for displaying bids and offers, matching orders, and clearing transactions, are also well known, especially for trading financial instruments. Such exchanges can operate electronically or non-electronically. Electronic exchanges include the Chicago Mercantile Exchange and its Globex™ system.

Some e-commerce sites, such as Amazon.com, feature recommendation engines which use statistical methods to analyze the shopping behavior of users in order to predict goods and services that the user would likely be interested in. These recommendation engines are able to suggest books and movies that a user is likely to enjoy based on other books and movies that the user has bought in the past.

“Intelligent agents” or “shopping agents” are a recent development in the domain of e-commerce. The idea is that computer programs, called “agents”, can persist on an electronic network, such as the Internet, and engage in commerce on behalf of a human principal. A consumer, for example, may have an agent charged with the task of finding and purchasing a list of goods at low prices. A seller, on the other hand, may have an agent charged with the task of offering and selling goods.

In practice, the use of e-commerce agents has been limited. One common manifestation of the “agent” concept has been shopping “bots”, which are essentially price comparison engines. Even in their limited role, many price comparison engines are not successful because merchants are often unwilling to disclose their pricing information. In the absence of information to process, e-commerce agents may have difficulty adding value to an electronic market.

While merchants are hesitant to provide pricing information to agents acting on behalf of consumers, most merchants do have a voracious appetite for information about potential and actual consumers. In particular, information about consumer demand for various products is highly sought after. Currently, this information is gathered by means of surveys. Occasionally, prizes and gifts are provided as incentives to consumers to persuade them to participate in surveys. One problem with surveys is that the answers provided by consumers are necessarily subjective, often biased, and therefore somewhat unreliable.

Information about consumer demand can also be gleaned from discussion forums. A common thread on internet forums is “If someone made X, I would buy it.” For example, on Slashdot, one frequently sees posts of the form, “If someone made a Linux™-powered X, for SY, I would buy it.” The usefulness of such a declaration for market research is limited as the statement is not backed by any obligation. They are fairly empty words. On the other hand, if the user could put up a sum of money, guaranteeing that he or she would buy the product if it became available, the statement would have real economic value. The problem, however, is that seldom would someone agree to provide such a guarantee for free. Unless the user is fairly compensated, it is unlikely to occur.

Markets, on the other hand, can be a reliable source of information. The Iowa Electronic Markets, for example, allow speculation on political events, thereby providing an estimate of the probabilities of each event occurring. In another domain, others have suggested a market mechanism for solving the current problem of unwanted e-mail or spam whereby a small sum of money is attached to each e-mail message. The recipient of the message can choose whether or not to receive that sum of money. Spammers would expect to lose money on their unwanted mailings. As a result, messages accompanied by money would likely not be spam.

One problem that may inhibit the further growth of e-commerce sites such as eBay is the issue of trust. Because the purchaser must send money, for example via PayPal, before receiving the goods, the buyer must rely on the honesty of the seller. Some auction sites address this issue by recording user feedback. A tally of positive and negative feedback is provided to users who wish to assess another user's reliability. Again, this is similar to the problem of obtaining reliable information from surveys. The problem with feedback as a measure of trust is that feedback is vulnerable to being “spoofed” or “spammed”. A user may use alter egos or associates to boost his or her rating. Although instances of fraud and conspiracy may be investigated, posting inaccurate feedback is not penalized if it stems from carelessness or a misguided sense of politeness. Consequently feedback accountability is limited.

### Options

An options contract is one whereby the option seller, also known as the “writer”, provides the option buyer the right, but not the obligation, to buy (in the case of a call option) or sell (in the case of a put option) a specified instrument, asset or property, known as the underlying instrument or asset or property, at a given price.

Options markets are widely used for trading options on financial instruments such as securities. One example is the Chicago Board Options Exchange, where options on equities are traded. The trading activity related to such derivatives often exceeds the activity for the underlying instruments. Options allow parties to transfer risk.

Given the above deficiencies in the current state of e-commerce and lending, there is a need for a system by which lenders may reduce their risk of holding unwanted property. Furthermore, there is a need for an electronic system for arranging the formation of options contracts on property, given that the current e-commerce systems arrange for trading in the transfer in ownership of the underlying goods themselves. There is therefore a need for an electronic system for trading derivative contracts on goods. In addition, there is a need for an electronic system that allows potential consumers to make binding promises to purchase a product which is not yet on the market. Finally, there is a need for market mechanisms to provide accurate and reliable information about the trustworthiness of participants in an electronic market.

### SUMMARY OF THE INVENTION

Many of the economic inefficiencies in pawnbroking and lending for security are due to the poor flow of information between the borrowers who put up property to use as security, the lender who accepts the property as security temporarily and, in cases of default, the ultimate buyer of the property. In cases of default, the lender assumes the role of a dealer in the property, accepting property from borrowers, and then selling the property to buyers. Since the lender's main business is credit and not the retailing of used goods or other property, its marketing operations are typically inefficient. One risk that the lender faces, then, is the risk of a default which results in the lender holding the property. Typically the property is not wanted and may be difficult to sell, resulting in a shortage of cash and waste of storage space.

A more efficient allocation of risk can be obtained by finding a person who is interested in owning the property that is put up as security for the loan. That person (the potential buyer) can undertake the risk of possibly buying the property in question. The relationship is that of a “put” options contract: the potential buyer offers the lender a put option on the property. In, for example, the case of default, the lender can then exercise the option, sell the property to the potential buyer, and recover value with which to extend further loans. By allowing a secured lender to buy put options from potential buyers of the property, the risk of owning property can be transferred to a person who is better suited to bearing that risk.

A “natural short position” is a situation where a party has an inherent need to buy a particular thing. For example, a baker has a natural short position in wheat, while an oil refiner has a natural short position in crude oil.

Depending on the situation, the need to buy may be urgent or may be flexible. Shoppers have a natural short position in the good for which they are shopping. Likewise, persons who are shopping for houses, cars, or intangibles such as intellectual property, also have natural short positions in those properties. Such persons may be in a position to write put options for those desired properties. Moreover, oftentimes, a potential buyer may want a good but not need it, and may therefore be flexible about when to buy it. In such cases, the potential buyer would not be much bothered by the uncertainty inherent in writing an option.

An objective of the present invention is to match borrowers, who have property that they wish to use as security, with potential purchasers of property, who are willing to own the security in the event of a default. Another objective of the present invention is to match lenders who are holding property, which they do not wish to own, with potential purchasers who are willing to sell “put options” on that properly, for example in the event of default

Existing options exchanges allow for trading in standardized options. Although this allows for efficient trading and high liquidity, it does not allow non-standardized property to be used as the underlying, and does not allow the specifications to be user-defined.

E-commerce sites, such as eBay™, on the other hand, allow for the buying and selling of almost anything a user can describe, subject to some restrictions. The marketplace is relatively free-form. However, such a marketplace is inconvenient for trading options, because the lack of structure makes it difficult to search for options meeting desired criteria. Morever, eBay™ allows user to post offers to sell, but not offers to buy.

As such, an aspect of the present invention is an Electronic Market System (EMS) through which potential purchasers can offer to sell put options on specific types of property, while lenders can seek to purchase those put options. The Electronic Market System comprises a software application operating on machines, such as for example a group of computers within a server farm, connected to an electronic network.

Another objective of the present invention is to allow potential purchasers of property such as goods to advertise their desire to purchase such property, and sell “put options” on such property to a willing buyer who may desire such “put options.”

Another objective of the present invention is to allow potential vendors of property such as goods to advertise their desire to sell such property, and buy “put options” on such property from a willing seller who may provide such “put options.”

### BRIEF DESCRIPTION OF THE FIGURES

FIG. 1 is network diagram showing an embodiment of the Electronic Market System of the present invention and its connections to other devices and systems.

FIG. 2 is a flowchart showing a use case for a borrower.

FIG. 3 is a flowchart showing a use case for a lender.

FIG. 4 is a flowchart showing a use case for a shopper, who is a potential option writer.

FIG. 5 is a flowchart showing an embodiment of the Electronic Market System receiving a bid or ask order.

FIG. 6 is a flowchart showing an embodiment of the Electronic Market System receiving instruction to fill a bid or ask order.

FIG. 7 is a flowchart showing an embodiment of the Electronic Market System receiving instruction to exercise an option.

FIG. 8 is flowchart showing an embodiment of the Electronic Market System receiving instruction to fill a bid order by reselling an existing option.

FIG. 9 is flowchart showing an embodiment of the Electronic Market System receiving instruction to place an ask order to resell an existing option.

FIG. 10 is a diagram showing an embodiment of a user interface for searching existing orders.

FIG. 11 is a diagram showing an embodiment of a user interface for posting a bid or ask order.

FIG. 12 is a diagram showing an embodiment of a user interface for viewing the details of an order.

FIG. 13 is a diagram showing an embodiment of a user interface for requesting a quote for a loan.

FIG. 14 is a flowchart showing an embodiment of a search for a loan with the system of the present invention.

FIG. 15 is a flowchart showing an embodiment of an auction for the present invention.

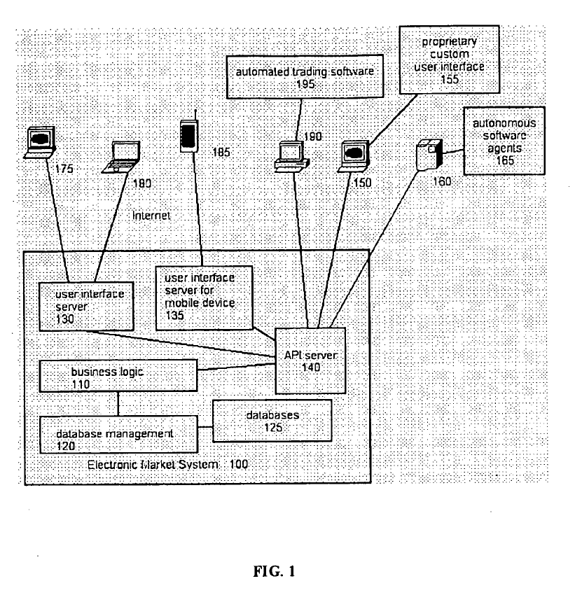

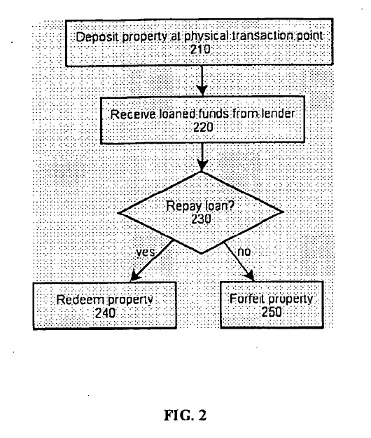

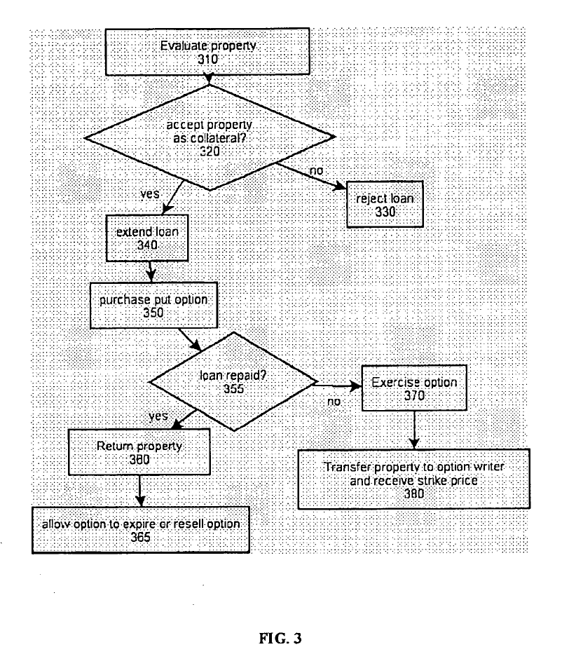

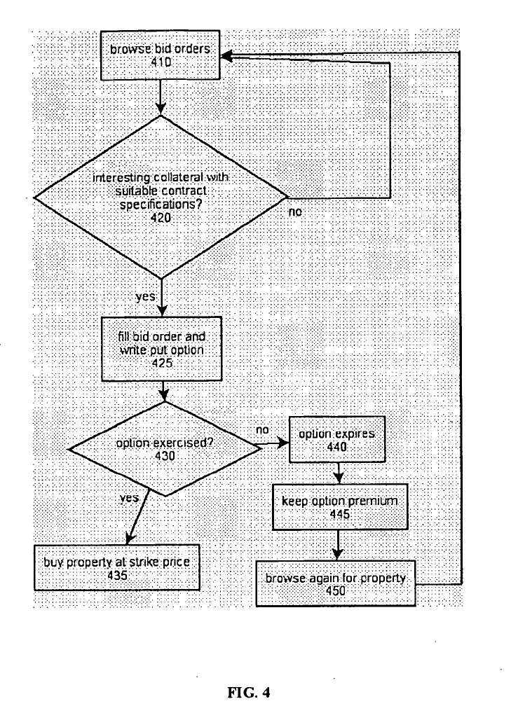

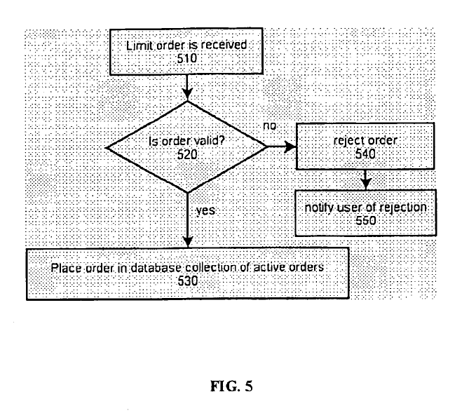

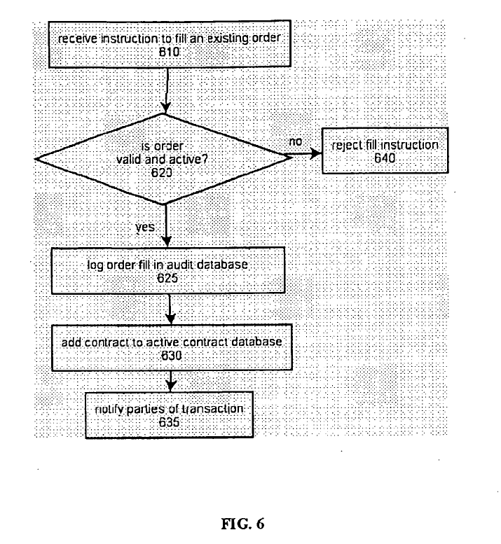

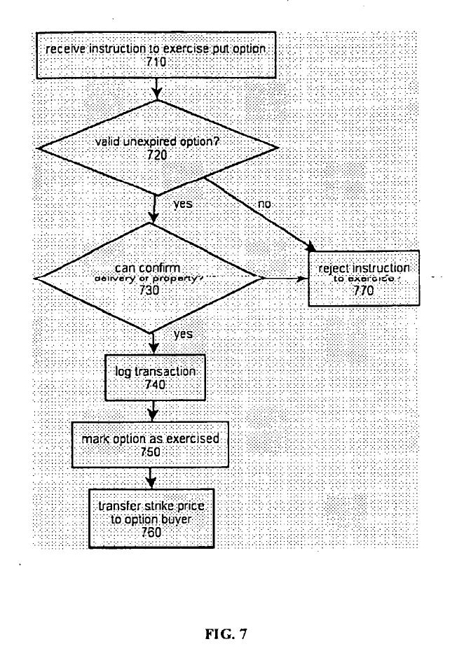

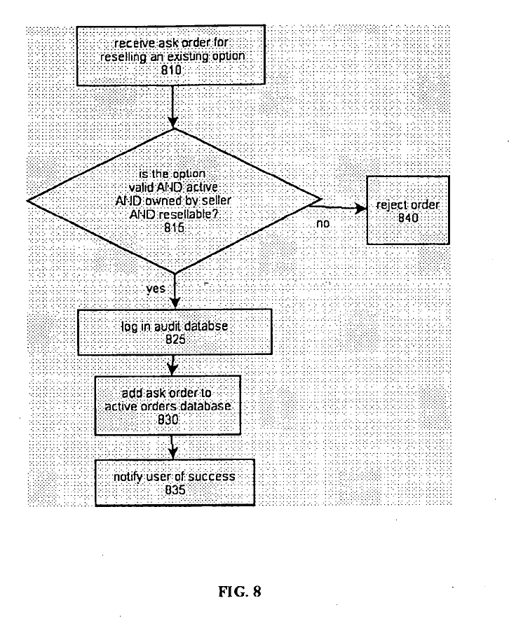

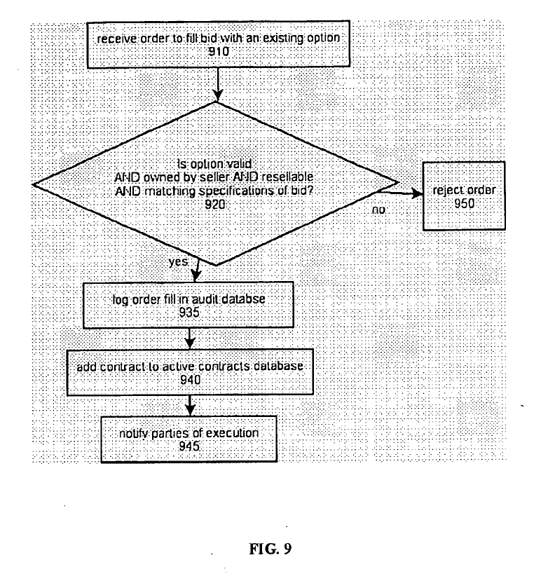

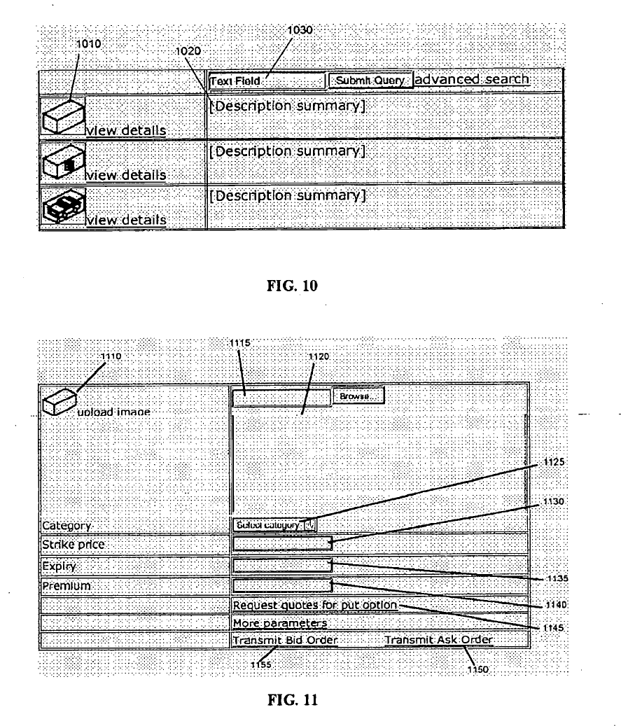

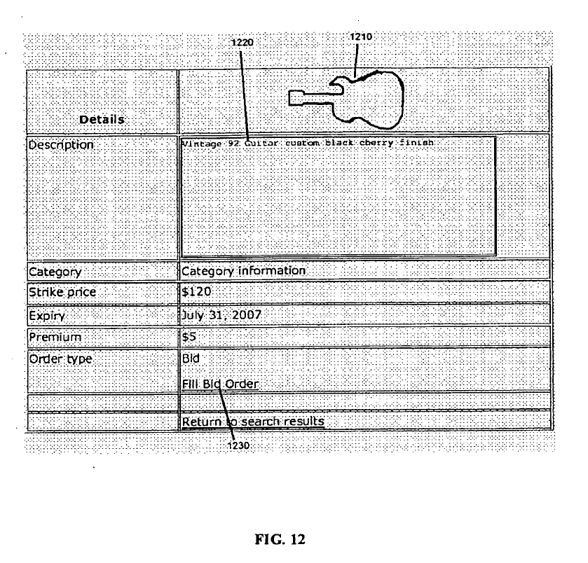

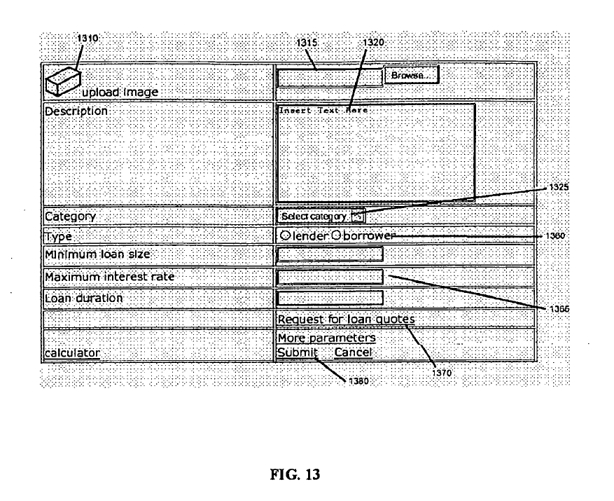

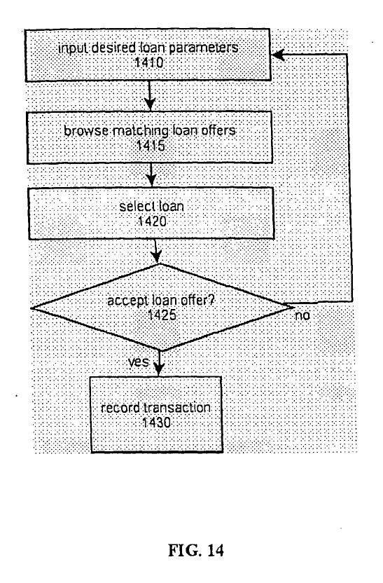

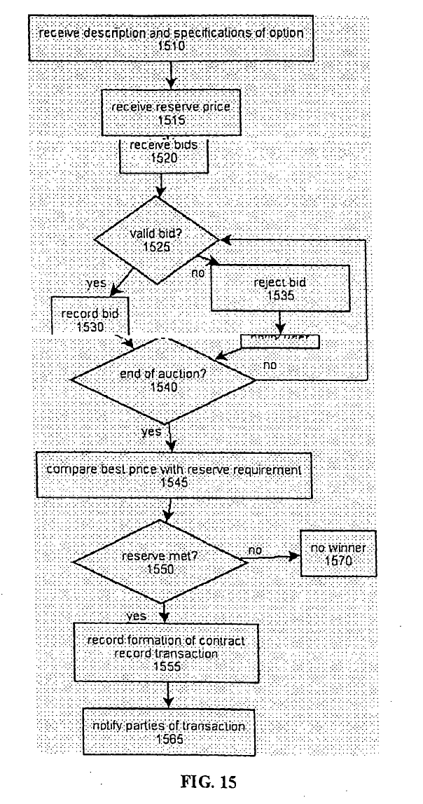

### DETAILED DESCRIPTION

### Terminology

A summary of certain terms is provided to reduce some of the potential questions with regard to those terms, as they are used in the specification and claims. It is to be understood that this summary is provided to assist the reader with understanding how the terms relate to each other, but the summary does not restrict the meaning of the terms. The figures and specification more fully establish the meaning for the terms.

An “ask” is an offer to sell a put option with a certain set of specifications at a certain price.

An “ask order” means an order placed with an electronic market system to sell at a given price.

A “bid” is an offer to buy a put option with a certain set of specifications at a certain price.

A “bid order” means an order placed with an electronic market system to buy at a given price.

A “borrower” is a user who borrows or is interested in borrowing from a lender, and has property to offer as collateral for the desired loan.

“Delivery” means the transfer of property from possession of one party to another or, in the case of real property or intangible property, the transfer of title on property from one party to another.

The “exchange” refers to an entity involved in the operation of an electronic market system of the present invention.

An “Exchange Agent” is an entity that has been registered with the Exchange as being authorized to hold property as security. An Exchange Agent can be present at a physical transaction point.

The “exercise” of an option for a given property means exercising the right to sell the underlying under the terms of the option contract.

A “lender” means a user who lends money to a borrower or is interested in lending. Lenders include pawnbrokers, mortgage lenders, title lenders and any other secured creditor.

An “option” is a derivative contract between two parties, an option seller and an option buyer, which gives the option buyer the right, but not the obligation, to buy or sell an underlying property to the option seller. A “call option” provides the buyer with the right to buy the underlying. A “put option” provides the buyer with the right to sell the underlying.

A “put option” is a derivative contract between two parties, a put option seller and a put option buyer, which gives the put option buyer the right, but not the obligation, to sell an underlying property to the option seller.

An “option buyer” or “put buyer” is a user who buys a put option on property, or is interested in buying a put option.

An “option writer” or “option seller” or “put seller” is a user who writes and sells a put option on property, or is interested in selling a put option.

A “potential buyer” or “buyer” is a user who has some interest in buying the property in question.

A “physical transaction point” is the geographical location where the property is deposited.

“Property” means a chose in possession or a chose in action. Property includes an item of tangible personal property or assets, as well as title to real property and intangible property.

The “strike price” is the price at which the underlying is bought or sold if and when the option is exercised.

An “underlying” is the instrument, property or asset to which an option contract relates, and which the option buyer has a right to sell by exercising a put option.

As such, an aspect of the present invention is an Electronic Market System (EMS) through which potential purchasers can offer to sell put options on specific types of goods, while lenders can seek to purchase those put options.

In an embodiment of the present invention, the Electronic Market System comprises of one or more server computers connected to an electronic network. A software application runs on the server computers and provides interfaces to users enabling them to place orders for the purchase and sale of put options on user-specifiable property.

In an embodiment of the present invention, the Electronic Market System comprises several servers in a server farm connected to the Internet. The servers include application servers and database servers.

In an embodiment of the present invention, one or more database servers provide database access including for storing and retrieving active orders, such as ask orders or bid orders, active option contracts, and logged transactions for auditing.

### Use Case

In one embodiment of the present invention, an example of a typical use scenario is as follows:

1. A borrower enters a pawn shop with a guitar and deposits it with the lender.
2. The pawn lender evaluates the property to see if it is satisfactory collateral for the loan. If the lender accepts the property as collateral, then the lender extends 5100 to the borrower for a month and holds the guitar as security.
3. The pawn lender purchases a put option through the Electronic Market System. To do so, the lender lists the guitar with the EMS, and indicates a strike price of $120, a premium of $5 and an expiry date of one month from the loan date. An option writer fills the lender's bid.
4. The lender pays the $5 premium to the option writer. A potential buyer of the guitar is the option writer who sells the desired option to the lender by leaving a deposit consisting of the strike price of $120 into an account for the purpose of ensuring the performance of transactions. Since the option writer received $5 as premium, the option writer only needed to have $115 beforehand in order to provide the $120 strike price.
5. If the borrower defaults on the loan conditions, then the lender would likely exercise the option: the lender delivers the guitar to the option writer and receives the strike price which was held as a deposit from the option writer.

On the other hand, if the borrower does not default on the loan conditions, then the lender returns the guitar to the borrower. The option expires unexercised. The deposit equal to the strike price is returned to the option writer.

### Use Case—Borrower

In one embodiment of the present invention, an example of a typical use scenario from the viewpoint of the borrower is as follows:

1. A borrower deposits a guitar at a pawn shop.
2. The borrower receives the loaned funds from the lender.
3. If the borrower repays the loan in accordance with the agreed to conditions, then the borrower redeems the guitar.
4. Otherwise, the borrower forfeits the guitar. The lender can then list the guitar as the underlying in a bid order.

### Use Case—Shopper

In one embodiment of the present invention, an example of a typical use scenario from the viewpoint of a shopper is as follows:

1. The shopper browses the bid orders in the Electronic Market System.
2. If the shopper finds bid orders with interesting collateral and suitable contract specifications, the shopper fills the order and writes the desired put option. The shopper becomes an option writer. As such, the shopper receives the specified premium, and places a deposit, equal to the strike price into an account to ensure performance of the contract.
3. If the option is exercised, then the shopper buys the property at the strike price: the amount held as deposit is transferred to the put buyer, and the property is transferred to the shopper.

If the option is not exercised, it expires. Once the contract has expired, the deposit is released back to the shopper. In addition, the shopper keeps the premium. The shopper can continue to browse for interesting collateral and suitable contract specifications.

### Options

In an embodiment of the present invention, an Electronic Market System is provided which allows users to post offers to buy or sell put options on property. In one use case, the option buyers are lenders, the option sellers are potential buyers of property, and the property is collateral that has been deposited with the lender as security for a loan.

A lender can therefore post the description of an item, stipulating, for example, maximum or minimum acceptable parameters for strike price, premium and expiration date. Potential buyers of items, who are put sellers, browse the listings to find personal items for which they are willing to sell put options. When an item for which a potential buyer is willing to sell a put is located, an offer to sell a put can be posted to the put buyer, along with specific details, such as, for example, strike price, premium, and expiration. If the terms are acceptable to the put buyer, the put buyer can accept the offer, and create the contractual relationship.

### Market Structures

In one embodiment of the present invention, the Electronic Market System provides a system for users to post messages listing the options that they wish to buy or sell. Users can send messages to one another through the system. Additionally, the system enables a user to send a formal contractual offer, containing all the specifications of an options contract the user who receives such an offer may formally accept the offer, thereby forming a contract. In one embodiment of the present invention, an offer that is not accepted may lapse or be withdrawn.

In another embodiment of the present invention, the market structure is that of a two-sided market.

In yet another embodiment of the present invention, the market structure is that of an auction wherein the buyers compete to provide the highest bid or the sellers compete to provide the lowest bid.

### Two-Sided Markets

The two-sided market enables put sellers to place ask orders, containing specifications for the put options being offered and the premium, or price, at which the options are to be sold. The Electronic Market System also enables put buyers to place bid orders, containing specifications for the put options being bid on, and the premium that the put buyer is willing to pay for the options. These active ask and bid orders may be accepted, or “filled”, by a user, thereby forming an options contract. When an order is placed, the person placing the order may specify that the order expires after a certain period of time (ie: an expiration date), or is valid until cancelled or withdrawn. Orders that have not been filled may be withdrawn. A messaging system allows users to post requests for orders, whereby the user specifies a range of parameters defining options acceptable to the user, and invites other market participants to provide suitable orders.

Given that the contract specifications are not necessarily standardized, it is difficult to establish rules for automatically matching orders, according to, for example, time and price priority. This is in contrast with options exchanges such as, for example, the Chicago Board Options Exchange, where standardized options allow the above matching rules to be applied. In one embodiment of the present invention, time and price priority are enforced only for contracts having the exact same specification. In another embodiment of the present invention, priority is not enforced, and a user may choose to fill any order he or she wishes, whether or not a “better” order exists. In other words, if two similar options are offered at different prices, the option buyer may fill the ask order with the higher price, even though a cheaper option with the same characteristics could be purchased.

In one embodiment of the present invention, an order is a message that comprises the following information:

1. a description of the property
2. a strike price
3. an expiration date
4. the premium
5. whether the order is a bid order or an ask order

In an embodiment of the present invention, the order can contain additional information, such as, for example, the terms of delivery for the property. The terms of delivery could include

[symbol]

In one embodiment of the present invention, ask orders and bid orders are both considered “limit orders”. When the Electronic Market System receives a limit order from a user, it verifies whether the order is valid. If the order is not valid, the system rejects the order and notifies the user. If the order is valid, it is approved and placed in a database collection of active orders.

In another embodiment of the present invention, when the Electronic Market System receives an instruction to fill an existing order, it verifies that the existing order is still valid and active. If it is not, the instruction to fill is rejected. If the existing order is valid and active, then the order fill is logged in an audit database. A new contract is added to the active contract database. The system notifies the parties of the transaction.

In yet another embodiment of the present invention, when the EMS receives an instruction to exercise a put option, it verifies that it is a valid unexpired option. If it is not, then the instruction is rejected. If it is, then the EMS confirms that the property will be delivered to the option writer. Once confirmed, then the exercise is logged as a transaction in the audit database, the option is marked as exercised and the strike price is transferred to the option buyer.

### Auctions

An auction can be composed of sellers competing to provide an equivalent option with the lowest premium. It can also be composed of buyers competing to pay the highest premium to buy the option. Other forms of auctions for the present invention are also contemplated.

In an auction, the auctioning party can specify the description of the property, delivery terms, strike price, expiry, a reserve, and an end-time for the auction. The reserve is, in the case of a put seller, the lowest acceptable premium, and, in the case of a put buyer, the highest acceptable premium.

Up until a fixed end-time corresponding, for example, to each property, auction participants can place bids. When the end-time is reached, the bid with the best price wins. In the case of an auction to sell an option, the bidders are buyers. The bidder with the highest premium would win the auction and therefore buy the option for that high premium. In the case of an auction to buy an option, the bidders are sellers. The bidder with the lowest premium would win and therefore sell the option for that low premium.

In an embodiment of the present invention, the Electronic Market System is instructed by a user to set up an auction. The system receives the description of the property and the specifications of the option contract. The system receives the reserve price, if any. The system is then ready to receive bids. When a bid is received, the system determines whether it is a valid bid. If not, then the bid is rejected and the bidder is notified. If the bid is valid, then it is recorded. While the auction has not yet reached its end, the system can continue to receive further bids for the auction. When the auction ends, the system compares the best price with the reserve requirement, if any. If there is a reserve requirement and it is not met, then there is no winning bid and hence no winner. If the reserve requirement is met then the system records the formation of a contract between the user who won the auction and the user who created the auction. Both parties are notified.

### Contract Specifications, Bids and Asks

### Messaging System

In an embodiment of the present invention, a messaging system is provided to enable users of the Electronic Market System to post a request for orders. A user who seeks to buy an option may post a request for asks. Conversely a user who seeks to sell an option may post a request for bids. These requests contain information specifying the attributes desired by the posting user, such as description of the property, expiry date, strike price, and premium. In another embodiment of the present invention, a message system is provided to enable users to request auctions.

In an embodiment of the present invention, the user is given the choice to attach or link one or more pictures of the item, typically for description.

Users may browse the database of requests, and search or filter using keywords and combinations of attributes and wild cards.

In an embodiment of the present invention, a private messaging system is provided, allowing a user to send a private message to another user, thereby allowing a willing buyer and seller to negotiate the terms of the options contract.

### User Interface for Searching Orders

In an embodiment of the present invention, a user interface allows a user to search the database of active orders. A field allows the user to search for a word or phrase. An advanced search page allows the user to enter additional specifications to narrow the results. From a list of results, the user can select one to be viewed in more detail. The order detail interface allows the user to view information regarding an offer, including an image, if available, and the text description. The interface allows the user to fill the order, if desired.

### User Interface for Option Buyers and Sellers

In an embodiment of the present invention, a user interface is presented to a user who is a put buyer or put seller. The interface enables the user to enter the information needed to place a bid or ask for a put option. The order is then transmitted to the Electronic Market System. The interface allows the user to upload a file containing an image, as well as to enter a description, select a category, specify the strike price, the expiry, and the premium. The interface also allows the user to request quotes for the option, thereby inviting other users to place orders.

In an embodiment of the present invention, the user interface enables the user to hold an auction to buy the put option. The interface allows the user to set the maximum premium for the option, and the duration of the auction.

### Option Seller Interface

In an embodiment of the present invention, a user interface is provided to a put seller to transmit an ask order to the Electronic Market System. Information about the order is available to put buyers. A given put buyer can “fill” the order to enter into an options contract with the put seller.

In an embodiment of the present invention where the put buyer has chosen to hold an auction, the put seller may make a bid by offering to sell the option for a premium that is less than the lowest current bid. If no bid has yet been made, in order to be accepted, the put seller's bid must be lower than the stipulated maximum acceptable premium.

### Deposits

A lender buys a put option in order to avoid the risk of owning collateral which may be forfeited by a borrower. As such, there should be little or no credit risk on the part of the put seller. Specifically, the lender should be confident that the put seller will be capable of accepting the goods and paying the strike price. There are two solutions to this problem. First, the put seller may be a trusted party. Alternatively, to ensure that the put seller is capable of taking delivery of the item, the put seller can place a deposit into an account sufficient to cover the cost of the item. In one embodiment of the present invention, the put seller can place a deposit in an account linked to the Electronic Market System, which is be sufficient to cover the cost of buying the collateral. The deposit is kept on hold, or “frozen”, until the option expires. If the nut expires without being exercised, the deposit is released. and the nut the put buyer's account in order to purchase the collateral, which is delivered to the put seller.

### Fees, Commissions and Accounting

In one embodiment of the present invention, a user is charged a commission each time the user sells an option. In one embodiment of the present invention, a user is charged a commission each time the user buys an option. In one embodiment of the present invention, a user is charged a commission each time the user exercises an option.

In an embodiment of the present invention, all users must own accounts linked to the Electronic Market System and where funds may be kept. Payments are effected by debiting and crediting these accounts. Funds that are held as deposit, such as when a user writes an option, may be temporarily withdrawn from the user's regular account and placed in a special account. Alternatively, the amount of the deposit may remain in the user's account, but be “frozen” or held and therefore inaccessible to the user until the option expires, at which point it is unfrozen, or alternatively, if the option is exercised, the deposit is withdrawn from the user's account and used to purchase the option's underlying at the strike price.

### Loaning of Deposits and Transferring Risk

In one embodiment of the present invention, The funds deposited by put sellers are held in accounts that are maintained by the exchange or an escrow agent. The exchange may therefore have access to a large amount of cash on hand. This cash can in turn be loaned to lenders. In one embodiment of the present invention, cash is loaned to a lender that has purchased put options through the Electronic Market System.

In one embodiment of the present invention, a borrower borrows $100 against the security of a guitar left at a pawnbroker. The pawnbroker buys a put option from a put seller, in which the option has a strike price of S130, paying a premium of $5. The put seller deposits $130 with the exchange. The exchange can then lend the pawnbroker $100.

It can be seen that in such an arrangement, most of the risk is due to the possibility of default by the borrower, and most of this risk is transferred to the put seller. The exchange can earn higher interest on a deposit, at relatively low risk, by lending it to a trusted pawnbroker that is also hedged from the risk of borrower default.

### Escrow

Just as the put buyer (i.e. the property seller) wishes to be assured of payment for the property that is sold, the put seller (i.e. potential buyer of the property) needs assurances that if the put is exercised, the property will indeed be delivered as agreed. In an embodiment of the present invention, the funds deposited by the put seller are held in escrow until the put buyer has delivered the item. Once an Exchange Agent confirms that the item is available and is to be delivered, then the appropriate funds are released or transferred to the put buyer who exercised the put. If the put buyer fails to present the item to the Exchange Agent, then the exchange can ensure that the exercise of the option is not approved, and ensure that no funds are inappropriately charged to the put seller.

In an embodiment of the present invention, before posting a bid for a put, the put buyer must have deposited the property with an Exchange Agent.

In another embodiment of the present invention, the put buyer is a pawnbroker, and is also an Exchange Agent. Since pawnbrokers typically are heavily regulated and relatively stable businesses, it may be reasonable, in one aspect of the present invention, to allow pawnbrokers to register as Exchange Agents with the exchange, thereby delegating to the pawnbrokers the responsibility of holding and delivering goods in a reliable manner. The Electronic Market System can allow for feedback by other users regarding the promptness and reliability of pawnbrokers in holding and delivering goods.

In yet another embodiment, the put buyer is another lender, such as a mortgage lender or a title lender, and is also an Exchange Agent.

### Second Use Case: Market Information

Another use of a put option with the Electronic Market System of the present invention is to allow would-be purchasers of a potential product to express interest in that product. Although consumers can post to forums to declare their interest, such posts do not carry as much weight as would a solid commitment. With the system of the present invention, however, a consumer can make a commitment to buy a product by selling put options.

In an embodiment of the present invention, a potential buyer can place an ask order in the Electronic Market System to sell put options for a product that is not yet available on the market. For example, the put seller is a potential product buyer who wishes to indicate the desired features of a good that does not yet exist, in order to prompt innovators to develop and sell the product.

Conversely, a merchant, who is not necessarily a pawnbroker, can place bids in the Electronic Market System to buy options to sell a product that is not yet available. For example, either a product may be in development or the manufacturer may be considering the size of its initial production run. Through such an arrangement, a company can have better assurances of a market for its product.

### Resale of Options

In an embodiment of the present invention, the Electronic Market System allows an option buyer to resell an unexpired option.

The option's owner can place an ask order for the option. If the order is filled, then the buyer becomes the new owner of the option.

In an embodiment of the present invention, the Electronic Market System receives an ask order for reselling an existing option. The system verifies that the option is valid, active, owned by the seller, and is resellable. If all of the conditions are met, the ask order is logged in an audit database. The ask order is then added to the active orders database, and the user is notified of success. Conversely, if the conditions are not met, the order is rejected and the user is notified of failure.

When this ask order is filled, this second option buyer is substituted for the old option owner. The active contracts database is updated to reflects this new situation. In this situation, the option owner who becomes an option reseller does not need to put up a deposit, because he or she is reselling an option that was bought, rather than writing a new option.

In an embodiment of the present invention, the owner of an option can sell it by using it to fill a bid order. When the Electronic Market System receives an order to fill a bid with an existing option, the system verifies that the option is valid, owned by the seller, resellable, and matches the specifications of the bid. If these conditions are met, the order fill is logged in an audit database, the contract information is updated in the active contracts database and the parties are notified of the execution. Again, no new option is written, and no further deposit is taken.

### Direct Loans

In another embodiment of the present invention, a borrower who has an item to use as collateral is matched to a lender who has some desire to own that item and who is therefore less averse to the risk of owning that item. An Electronic Market System is provided which matches borrowers who own goods that they wish to use as security, with lenders who are not particularly averse to owning that security. As such, lower interest rates or higher loan sizes may be made available to borrowers.

A lender can place offers with the Electronic Market System such as in the form of an electronic message concerning the description of the property, the terms of delivery, the size of the loan, the length of the loan, and the interest rate.

A borrower can place offers with the Electronic Market System concerning similar parameters.

Either lenders or borrowers search the database of offers by inputting desired loan parameters. The user browses matching offers and selects the loan offer to view it in more detail. If the user accepts a loan agreement, then a contract is formed and the transaction is recorded.

Alternatively, an auction is provided wherein a borrower posts a message containing the description of the goods, the terms of delivery, the size and duration of the loan, and a maximum interest rate. Bidders can then compete to offer the lowest interest rate. If the winning bid has an interest rate lower than the maximum acceptable rate, a contract is formed between the bidder, who becomes the lender, and the borrower.

In an embodiment of the present invention, a market participant is presented with an interface enabling the lender to place several orders such that, as soon as one order is filled, the other orders are withdrawn. For example, a potential lender might make five offers to lend money in response to five different auctions. If one such offer is accepted, the other four offers are to be taken off the market. This may be desirable if, for example, the lender is willing to own a plasma screen television set but not five of them, and has made bids on five loan requests each describing a plasma screen television set.

### Borrower Interface for Making a Loan Request

In an embodiment of the present invention, the user who posts a request for orders is provided with an interface allowing the user to upload an image of the collateral. The interface also allows the user to enter a description. The user may include a category descriptor for the property offered as collateral, for example, by specifying whether the item belongs to a given category such as electronics, home video, home audio, compact discs, movies, appliances, books, games, or collectibles. Fields are provided where the user can enter information such as minimum loan size, maximum interest rate, and loan duration. The interface allows the user to request loan quotes based on the entered information. The interface also allows the user to search the database for existing loan offers that match the entered specifications.

### Interface for Browsing Offers and Requests

The Electronic Market System enables the user to browse a filtered or unfiltered list of loan offers and requests. In response to a request for an offer, a user may make a formal contractual offer. Acceptance of the offer creates a contract. In an embodiment of the present invention, a lender can specify that the loan offer is valid for a specified period of time or can withdraw an offer which has not yet been accepted.

The borrower then brings the collateral to a physical transaction point, where an Exchange Agent confirms that the property conforms to the description specified in the contract. The item is put into storage, and the agreed upon funds are disbursed to the borrower and deducted from the lender's account with the exchange. Fees such as, for example, storage, insurance and administration can be deducted as appropriate in accordance with the terms of the loan agreement.

In one embodiment of the present invention, a physical transaction point is equipped with an Electronic Market System terminal comprising an electronic device connected to the Electronic Market System. The physical transaction point is a geographical location where items am deposited. The property is accepted from the borrower by an Exchange Agent and money disbursed to the borrower. The transaction location may, for example, be a retail location, such as a separate shop, or it may be a kiosk within a store. The terminal may have specialized software, or generic software such as a web browser. The electronic device connected to the Electronic Market System is operated by an Exchange Agent, who is authorized to access certain special functions on the Electronic Market System in order to perform his or her duties.

In an embodiment of the present invention, the Exchange Agent is an employee or agent of a company operating the Electronic Market System. In another embodiment of the present invention, the Exchange Agent is a person who has registered with the exchange and has privileges on the EMS that enable the Exchange Agent to accept property as security. For example, a pawnbroker may register to be an Exchange Agent and have an Electronic Market System terminal on the premises.

### Repayment and Prepayment

In an embodiment of the present invention, repayment may be effected up to the last day indicated in the loan agreement. Prepayment of a loan can be accepted, depending on the terms of the loan agreement. The Electronic Market System allows terms to be specified pertaining to prepayments.

### Refinancing

In one embodiment of the present invention, a borrower may repay a loan and, simultaneously, enter into a new loan, involving the same property.

As the end of a loan period approaches, the borrower may indicate that the property is open for refinancing. Potential lenders may make competing offers to lend against the property. If the borrower agrees to a new loan against the property, the new loan is used to repay the first loan. Depending on the amount of the new loan, the borrower may need to advance additional funds to pay off the first loan.

For example, a borrower has borrowed $250 using a television set as security. The borrower could refinance the television set by creating a new $250 loan to pay off the first $250 loan, while paying $10 in accrued interest on the first loan.

### Business Models

The above technical description of the Electronic Market System can be combined with a number of different business structures.

In one embodiment of the present invention, borrowers are members of the public, while lenders are businesses such as pawnbrokers, title lenders or mortgage lenders who have registered with the exchange. A company runs the exchange and earns fees by providing electronic matching services.

In another embodiment of the present invention, both the borrowers and lenders are members of the public who register with the Electronic Market System using, for example, a web browser, mobile phone, or other electronic device. A company runs the Electronic Market System, provides physical transaction points and earns fees by providing the electronic matching service, as well as storage services, insurance services, and other forms of infrastructure.

In another embodiment of the present invention, the company running the Electronic Market System directly provides loans to the borrowers and uses the system to offset risk on the loans. Therefore, the company acts as a lender, and buys put options against specific items which may be difficult to resell should the borrower default. Put sellers register with the exchange in order to offer put options and purchase goods.

Alternatively, the company is a lender that uses the Electronic Market System to refinance loans through other lenders as needed to offset risk and maintain liquidity.

### Calculator

In an embodiment of the present invention, a loan calculator tool is accessible to users of the Electronic Market System such as by clicking on a button on a web page. The loan calculator enables the user to specify the amount of the loan to be repaid based on parameters such as interest rate and repayment date, or the interest rate based on the amount to be repaid and repayment date. In an embodiment of the present invention, the loan calculator also allows the user to enter a user-defined formula to calculate other values. The loan calculator also allows the user to access stored formulas to calculate a variety of values.

### Suggested Matches

In one embodiment of the present invention, the Electronic Market System provides lenders and borrowers a list of potential matches based on the preferences of those users. Statistical methods may be used to infer user preferences based on their previous activities. A recommendation engine analyzes the searches and transaction history of a user in order to predict which orders, among the active orders, have specifications and descriptions most likely to appeal to the user. The engine can then provide the user with a list of recommended orders which the user is likely to be interested in filling.

### Hardware and Software

In an embodiment of the present invention, the Electronic Market System comprises a software application running on one or more computers connected to an electronic network.

In an embodiment of the present invention, the software is an n-tier web application running on one or more servers connected to the Internet. The user interface is provided by one or more web applications creating dynamic web pages from information provided by a “business logic tier” such as would be understood by a worker skilled in the art. For example, the web application is implemented in PHP, Java, Ruby, or other programming languages known to a worker skilled in the art. Web pages can be served using Apache, for example, or other web servers such as would be known to a worker skilled in the art. Multiple servers may be used in a load-balancing or other suitable configuration in order to accommodate a large number of concurrent users. Network security over the Internet may be provided by using encrypted connections, such as by using SSL.

In an embodiment of the present invention, a user interface for mobile devices is provided by servers that deliver simple web content and WAP content. For devices supporting it, network security may be provided by using encrypted connections.

In an embodiment of the present invention, the user interface is provided by a stand-alone client application that communicates with the Electronic Market System over the internet using an encrypted channel.

In an embodiment of the present invention, an application programming interface provides the interface between the various user interfaces and the business logic layer of the Electronic Market System.

In an embodiment of the present invention, an Electronic Market System stores its data in databases such as, for example, Oracle™, MySQL™, PostgreSQL™, or another suitable databases. The various databases contain information such as, for example, user profiles, active bid and ask orders, fill instructions, matched trades, current and past transactions for auditing. In an embodiment of the present invention, a database management layer provides an interface between the business logic and the databases.

In an embodiment of the present invention, a financial transaction server is used to handle transfers of funds between users.

### Application Programming Interface (API)

In one embodiment of the present invention, a user API is exposed to users of the Electronic Market System, allowing them to develop their own methods of interacting with the system.

In one embodiment, an object-oriented programming approach is used. The API provides objects for creating new orders, searching orders, and hitting orders.

A “new order” object possesses attributes such as the description of the property, the expiration date, the terms of delivery, strike price, the premium and bid or ask.

An order is transmitted by invoking the “transmit order” method of the system object with the now order object as the parameter.

A search for orders can be made by sending a message to the Electronic Market System object with parameters specifying the way in which results are to be filtered. The method returns a list of existing order objects. From this list, if an order object is found that satisfies the needs of the user, the user can “fill” that order by invoking the fill method of that order object.

In another embodiment of the present invention, an user API is provided for accessing an auction market. The user API provides methods for sending messages to the Electronic Market System. A “create auction” method allows users to specify the terms of an auction, and initiate an auction. A “search” method allows users to search for auctions, based on search parameters. A “bid” method allows users to bind in existing auctions. The API allows methods.

### Intelligent Agents and Automated Trading

In an embodiment of the present invention, the API is accessed by users who wish to implement their own customized user interfaces or wish to implement automated trading strategies. For example, intelligent agents can search the Electronic Market System for arbitrage opportunities and automatically execute trades on behalf of their owners. For example, in a market without automatic matching rules, a bid order may exist with a higher price, and an order may exist with a lower price, both orders being for contracts with the same specifications. An intelligent agent could buy at the lower ask and simultaneously sell at the higher ask, thereby making a profit.

Furthermore, a user who wishes to buy or sell a large number of options may wish to use automated trading. For example, a company that has developed a product and wishes to buy a large number of put options prior to beginning a production run can develop and use an intelligent agent to purchase these options, rather than having to manually place a large number of bids or fill a large number of asks. Automated trading strategies can be used to test the market at various price levels and with varying contract specifications.

### User Interface

In an embodiment of the present invention, the networked electronic device may be, for example, a desktop or notebook computer connected to the network, a mobile phone with WAP browser, a mobile phone with a Java™ application, a PDA such as a Palm™ or PocketPC™ device, a tablet computer, or any other networked electronic device such as would be known to a worker skilled in the art. The device's connectivity may be in the form of internet access, wired or wireless data access, a virtual private network, or other network connectivity such as would be known to a worker skilled in the art.

In an embodiment of the present invention, the user interface is provided by a web interface hosted on an internet-connected web server. In another embodiment of the present invention, the user interface is provided by a stand-alone application, for example a Java™ application for mobile devices.

The foregoing has constituted a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

1. An electronic market system for facilitating a transaction between an option buyer and an option seller, the system comprising:
a database of bid orders on property that stores information regarding at least one bid order,
a database of ask orders on property that stores information regarding at least one ask order,
at least one workstation that allows a user to specify inputs that fill at least one bid order or at least one ask order, and
at least one trading server, responsive to said workstation and connected to said databases, that facilitates the exercise of an option contract by using said specified inputs from said user.

2. A method of facilitating a transaction between an option buyer and an option seller comprising the steps of:
a) the option buyer extending a loan to a borrower for a fixed period, and accepting property to hold as security for the loan;
b) the option buyer buying a put option on the property for a premium from the option seller; wherein the put Option comprises a description of the property, a strike price and an expiration date; and
c) the borrower defaulting on payment of the loan at the end of the fixed period and forfeiting the property in favor of the option buyer.

3. The method of claim 2 further comprising the steps of:
d) the option buyer exercising the put option no later than the expiration date; and
e) the property being transferred to the option seller.

4. The method of claim 3 further comprising the step of:
f) funds in the amount of the strike price being transferred to the option buyer.

5. A method of facilitating a transaction between an option buyer and an option seller comprising the steps of:
a) the option buyer placing a bid order to buy a put option on property; and
c) the option seller agreeing to sell the put option to the option buyer by filling the bid order.

6. The method of claim 5 wherein the property is owned by a third party when the bid order is placed.

7. The method of claim 5 wherein the bid order is placed in an electronic market system.

8. A method of facilitating a transaction between an option buyer and an option seller comprising the steps of:
a) the option seller placing an ask order to sell a put option on property; and
b) the option buyer agreeing to buy the put option from the option seller by filling the ask order.

9. The method of claim 8 wherein the property is owned by a third party when the ask order is placed.

10. The method of claim 8 wherein the ask order is placed in an electronic market system.

11. The method of claim 2, 5 or 8 wherein the property is selected from the group consisting of real property, tangible personal property and intangible personal property except financial instruments.

12. The method of claim 2 wherein the end of the fixed period is before or on the expiration date.

13. The method of claim 12 wherein the tangible personal property is held at a physical transaction point during the fixed period.

14. The method of claim 3 wherein the property is tangible personal property that is held at a physical transaction point prior to being transferred to the option seller.

15. The method of claim 3 wherein the step of transferring the property comprises the option buyer delivering the property to the option seller.

16. A method of facilitating a transaction between a put option buyer and a put option seller comprising the steps of:
a) the option buyer extending a loan to a borrower for a fixed period, and accepting property to hold as security for the loan;
b) the option buyer buying a put option on the property for a premium from the option seller; wherein the put option comprises a description of the property, a strike price and an expiration date; and
c) the borrower not defaulting on payment of the loan at the end of the fixed period thereby avoiding forfeit of the property.

17. The method of claim 16 further comprising the steps of:
d) the option buyer allowing the put option to expire; and
e) the strike price being released to the option seller.

18. The method of claim 17 further comprising the step of:
f) the property being returned to the borrower.

19. A method of facilitating a transaction between a put option buyer and a put option seller comprising the steps of:
a) extending a loan to a borrower for a fixed period, and accepting property to hold as security for the loan;
b) buying a put option on the property from the option seller for a premium; wherein the put option comprises a description of the property, a strike price and an expiration date; and
c) obtaining title to the property on default of the loan by the borrower at the end of the fixed period.

20. The method of claim 19 further comprising the steps of:
d) exercising the put option no later than the expiration date; and
e) transferring the property to the option seller.

21. A method of facilitating a transaction between a put option buyer and a put option seller through an electronic market system comprising the steps of:
a) the option buyer extending a loan to a borrower for a fixed period, and accepting property to hold as security for the loan;
b) the option buyer using the electronic market system to buy a put option on the property for a premium from the option seller; wherein the put option comprises a description of the property, a strike price and an expiration date;
c) the borrower defaulting on payment of the loan at the end of the fixed period and forfeiting the property in favor of the option buyer;
d) the option buyer allowing the put option to expire after the expiration date; and
e) the strike price being released to the option seller.

22. A method of facilitating a transaction between a put option buyer and at least one put option seller through an electronic market system comprising the steps of:
a) the option buyer extending a loan to a borrower for a fixed period, and accepting property to hold as security for the loan;
b) the option seller placing an ask order with the electronic market system to sell a put option on the property, wherein the put option comprises a description of the property, a strike price, a premium and an expiration date;
c) the option buyer agreeing to buy the put option by filling the ask order;
d) the premium being debited from an account associated with the option buyer and credited to an account associated with the option seller;
e) the borrower defaulting on payment of the loan at the end of the fixed period and forfeiting the property in favor of the option buyer,
f) the property being transferred to the option seller, and
g) the strike price being debited from the account associated with the option seller.

23. A method of facilitating a transaction between a put option buyer and at least one put option seller through an electronic market system comprising the steps of:
a) the option buyer extending a loan to a borrower for a fixed period, and accepting property to hold as security for the loan;
b) the option buyer placing a bid order with the electronic market system to buy a put option on the property, wherein the put option comprises a description of the property, a strike price, a premium and an expiration date;
c) an option seller agreeing to sell the put option by filling the bid order;
d) the premium being debited from an account associated with the option buyer and credited to an account associated with the option seller;
e) the borrower defaulting on payment of the loan at the end of the fixed period and forfeiting the property in favor of the option buyer;
f) the property being transferred to the option seller, and
g) the strike price being debited from the account associated with the option seller.

24. An apparatus for facilitating a transaction between an option buyer and a plurality of option sellers, comprising:
a storage device; and
a processor connected to the storage device, the storage device storing a program for controlling the processor; and
the processor operative with the program to:
receive a bid order from the option buyer to buy a put option on property, the bid order comprising a strike price and a premium;
receive a payment identifier specifying an account, the payment identifier being associated with the bid order;
make the bid order available to the plurality of option sellers after receiving the payment identifier;
receive an acceptance from an option seller to sell the put option, the acceptance being responsive to the bid order;
provide the premium to the option seller by using the payment identifier;
receive an indication from the option buyer that the option is exercised; and
provide funds amounting to the strike price to the option buyer by using the payment identifier.

25. An apparatus for facilitating a transaction between an option seller and a plurality of option buyers, comprising:
a storage device; and
a processor connected to the storage device,
the storage device storing a program for controlling the processor; and
the processor operative with the program to:
receive an ask order to sell a put option on property, the ask order comprising a strike price and a premium;
receive a payment identifier specifying an account, the payment identifier being associated with the ask order;
make the ask order available to the plurality of buyers after receiving the payment identifier;
receive an acceptance from a buyer to buy the put option, the acceptance being responsive to the ask order;
provide the premium to the seller by using the payment identifier,
receive an indication from the buyer that the option is exercised; and
provide funds amounting to the strike price to the buyer by using the payment identifier.

26. The apparatus of claim 24 wherein the bid order further comprises a description of the property.

27. The apparatus of claim 25 wherein the ask order further comprises a description of the property.
